(19) United States
(12) Patent Application Publication
(10) Pub. No.: US 2023/0394332 A1
(43) Pub. Date: Dec. 7, 2023

(54) DETERMINING TARGET POLICY PERFORMANCE VIA OFF-POLICY EVALUATION IN EMBEDDING SPACES

(71) Applicant: Adobe Inc., San Jose, CA (US)

(72) Inventors: Jaron J.R. Lee, Baltimore, MD (US); David Arbour, San Jose, CA (US); Georgios Theocharous, San Jose, CA (US)

(21) Appl. No.: 17/804,991

(22) Filed: Jun. 1, 2022

(51) Int. Cl. G06N 5/04; G06F 11/34; G06F 11/30

(52) U.S. Cl. CPC G06N 5/04; G06F 11/3409; G06F 11/3006; G06F 11/3476

(57) ABSTRACT

The present disclosure describes methods, systems, and non-transitory computer-readable media for generating a projected value metric that projects a performance of a target policy within a digital action space. For instance, in one or more embodiments, the disclosed systems identify a target policy for performing digital actions represented within a digital action space. The disclosed systems further determine a set of sampled digital actions performed according to a logging policy and represented within the digital action space. Utilizing an embedding model, the disclosed systems generate a set of action embedding vectors representing the set of sampled digital actions within an embedding space. Further, utilizing the set of action embedding vectors, the disclosed systems generate a projected value metric indicating a projected performance of the target policy.

### BACKGROUND

In recent years, computer-implemented technologies have improved software platforms for evaluating the performance of various policies (e.g., computer-implemented models or algorithms), such as policies for providing digital content. To illustrate, off-policy evaluation methods have been developed to determine the expected value of a new target policy using data collected under a previously implemented policy (i.e., a logging policy). These off-policy methods are often utilized to predict the performance of the target policy without deploying the target policy. Despite these advances, conventional policy evaluation systems that employ these methods are often inflexible in the target policies that can be evaluated and computationally inefficient in their approach. Further many of these conventional policy evaluation systems fail to accurately estimate the performance of target policies—particularly in large action spaces—leading to the deployment of sub-optimal policies.

### SUMMARY

This disclosure describes one or more embodiments of methods, non-transitory computer-readable media, and systems that solve one or more of the foregoing problems and provide other benefits. For example, in one or more embodiments, the disclosed systems generate embedding vectors for off-policy evaluation of a computer-implemented policy (e.g., a recommendation policy). To illustrate, in some embodiments, the disclosed systems generate embedding vectors—such as by using a neural network—to represent digital actions and/or contexts (e.g., queries) within an embedding space. The disclosed systems further utilize the embedding vectors to estimate the performance of a target policy via causal inference. For instance, in some cases, the disclosed systems generate a metric that estimates the performance by using the embedding vectors to compare the target policy to a previously implemented logging policy. In some implementations, the digital actions represented by the embedding vectors include one or more digital actions that were unobserved under the logging policy. In this manner, the disclosed systems flexibly, efficiently, and accurately evaluate target policy performance, allowing for the deployment of optimal policies that facilitate more accurate response to context inputs.

Additional features and advantages of one or more embodiments of the present disclosure are outlined in the following description.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 an example system environment in which a off-policy embedding evaluation system can operate in accordance with one or more embodiments.

FIG. 2 illustrates an overview diagram of the off-policy embedding evaluation system predicting the performance of a target policy using action embedding vectors in accordance with one or more embodiments.

FIG. 3 illustrates a diagram for generating a projected value metric for a target policy using an estimated density ratio in accordance with one or more embodiments.

FIGS. 4A-4B illustrate graphs reflecting experimental results regarding the effectiveness of the off-policy embedding evaluation system in accordance with one or more embodiments.

FIG. 5 illustrates a graph reflecting additional experimental results regarding the effectiveness of the off-policy embedding evaluation system in accordance with one or more embodiments.

FIG. 6 illustrates an example schematic diagram of an off-policy embedding evaluation system in accordance with one or more embodiments.

FIG. 7 illustrates a flowchart of a series of acts for generating a projected value metric that estimates the value of a target policy within a digital action space in accordance with one or more embodiments.

FIG. 8 illustrates a block diagram of an exemplary computing device in accordance with one or more embodiments.

### DETAILED DESCRIPTION

The disclosure describes one or more embodiments of an off-policy embedding evaluation system that performs off-policy evaluation of a target policy utilizing embedding vectors that summarize the attributes of digital actions from a digital action space. Indeed, in one or more embodiments, the off-policy embedding evaluation system utilizes an embedding model, such as an embedding neural network, to generate embedding vectors that represent the digital actions. In some cases, the represented digital actions include digital actions that are unobserved under a logging policy previously employed within the digital action space. In one or more embodiments, the off-policy embedding evaluation system utilizes the embedding vectors to predict the performance of the target policy within the digital action space. For instance, in some cases, the off-policy embedding evaluation system utilizes the embedding vectors to compare the target policy to the logging policy and generates a projection metric utilizing the comparison.

To provide an illustration, in one or more embodiments, the off-policy embedding evaluation system identifies a target policy for performing digital actions represented within a digital action space. Additionally, the off-policy embedding evaluation system determines a set of sampled digital actions performed according to a logging policy and represented within the digital action space. Utilizing an embedding model, the off-policy embedding evaluation system generates a set of action embedding vectors representing the set of sampled digital actions within an embedding space. Further, the off-policy embedding evaluation system generates a projected value metric indicating a projected performance of the target policy utilizing the set of action embedding vectors.

As just mentioned, in one or more embodiments, the off-policy embedding evaluation system determines a projected performance of a target policy within a digital action space. Indeed, in some embodiments, the off-policy embedding evaluation system determines the projected performance without deploying the target policy within the digital action space. In some cases, the off-policy embedding evaluation system determines the projected performance by estimating the value of digital actions performed by the target policy in response to some context. For example, in some instances, the off-policy embedding evaluation system generates a projected value metric that indicates the projected performance of the target policy within the digital action space.

Additionally, as mentioned above, in some embodiments, the off-policy embedding evaluation system utilizes action embedding vectors to determine the projected performance of the target policy within the digital action space. Indeed, in one or more embodiments, the off-policy embedding evaluation system generates action embedding vectors for digital actions from the digital action space. In some embodiments, the action embedding vectors summarize the digital actions within an embedding space. In some cases, the off-policy embedding evaluation system utilizes an embedding model (e.g., a neural network) to generate an action embedding vector for a digital action. Further, in some implementations, the off-policy embedding evaluation system utilizes the action embedding vectors to generate the projected value metric for the target policy.

As further mentioned, in one or more embodiments, the off-policy embedding evaluation system determines the projected performance of the target policy (e.g., generates the projected value metric for the target policy) based on a logging policy previously employed within the digital action space. To illustrate, in some cases, the off-policy embedding evaluation system monitors, collects, receives, or samples digital actions performed by the logging policy within the digital action space. The off-policy embedding evaluation system utilizes the digital actions of the logging policy in determining the projected performance of the target policy. In particular, in some embodiments, the off-policy embedding evaluation system generates action embedding vectors for the digital actions of the logging policy and utilizes the action embedding vectors to determine the projected performance.

In one or more embodiments, the off-policy embedding evaluation system utilizes a density ratio of the target policy to the logging policy to determine the projected performance of the target policy. In some cases, the off-policy embedding evaluation system estimates the density ratio using binary probabilistic classification. To illustrate, in one or more embodiments, the off-policy embedding evaluation system samples digital actions from the target policy and the logging policy, utilizes a probabilistic binary classifier to determine the policy a given digital action is from, and utilizes the outputs of the probabilistic binary classifier to estimate the density ratio. The off-policy embedding evaluation system utilizes the estimated density ratio to generate the projected value metric for the target policy.

In some embodiments, the digital actions from the target policy are unobserved under the logging policy. In other words, the logging policy did not perform the digital actions while implemented within the digital action space. For example, in some implementations, the digital action space is large (e.g., comprising a large number of possible digital actions) or dynamic (e.g., having digital actions that are periodically added). Accordingly, in some cases, the logging policy did not perform all possible digital actions from the digital action space.

In one or more embodiments, the off-policy embedding evaluation system further deploys the target policy. In particular, in some cases, the off-policy embedding evaluation system implements the target policy to perform one or more digital actions within the digital action space. In some implementations, the off-policy embedding evaluation system deploys the target policy based on the predicted performance determined for the target policy (e.g., whether the predicted performance satisfies a performance threshold or exceeds the performance of the logging policy).

As mentioned above, conventional off-policy evaluation systems suffer from several technological shortcomings that result in inflexible, inaccurate, and inefficient operation. In particular, many conventional policy evaluation systems are inflexible in that they employ methods of predicting performance that limit the target policies that can be evaluated. For instance, conventional policy evaluation systems that implement off-policy evaluation often rely on adherence to absolute continuity when evaluating target policies. Absolute continuity requires that the probability of a digital action under the logging policy be greater than zero when the probability of the digital action under the target policy is greater than zero. Where absolute continuity is violated, the conventional policy evaluation systems typically cannot evaluate a target policy. Many digital action spaces, however, are large and/or change periodically (e.g., by adding new digital actions), leading to unobserved digital actions under a logging policy. Accordingly, there may exist target policies that provide a non-zero likelihood of a digital action where that digital action remains unused by the logging policy. Thus, conventional policy evaluation systems may be limited in the target policies that can be evaluated, particularly for large and/or changing digital action spaces.

Further, conventional off-policy evaluation systems often suffer from inaccuracies. For example, conventional policy evaluation systems often fail to accurately predict the performance of a target policy, especially where the digital action space is large. For instance, many existing systems generate one or more projection metrics to estimate the value of a target policy's performance within a digital action space; but such systems tend to generate metrics that fail to accurately estimate that value. As deployment of policies may depend on these projection metrics, the failure of conventional policy evaluation systems to generate accurate projection metrics often leads to implementation of a sub-optimal policy within a digital action space. As a result, the downstream applications that rely on these policies also fail to operate accurately. For instance, a recommendation system using a sub-optimal policy may fail to provide a recommendation that accurately reflects a query.

In addition to inflexibility and inaccuracy problems, conventional off-policy evaluation systems can also operate inefficiently and can burn through significant computational resources. For instance, in order to perform off-policy evaluation, many conventional policy evaluation systems utilize representations of digital actions that require large amounts of digital data (e.g., categorical one-hot vectors that represent the total digital action space). Accordingly, conventional policy evaluation systems typically require a significant amount of computing resources, such as memory and processing power, to process these digital action representations. Further, existing systems typically utilize digital actions that are observed under the logging policy for the off-policy evaluation. These systems, however, often rely on servers to perform thousands to millions of client device interactions to collect data for these observed digital actions. Such testing and collection can require months or years of back-and-forth internet communications between the servers and the client devices to collect the data and perform the evaluation. Such a method can be extremely demanding computationally and engage a host of computing devices and incalculable computer processing over time.

The off-policy embedding evaluation system provides several advantages over conventional policy evaluation systems. For example, by utilizing action embedding vectors to generate the projected value metric for a target policy, the off-policy embedding evaluation system provides for improved flexibility over conventional policy evaluation systems. In particular, by utilizing action embedding vectors within an embedding space, the off-policy embedding evaluation system employs off-policy evaluation free of absolute continuity constraints. Indeed, the off-policy embedding evaluation system can evaluate a target policy that may perform a digital action that was unobserved under the logging policy, which is an absolute continuity violation. Thus, the off-policy embedding evaluation system can more robustly evaluate target policies for a given digital action space and can evaluate target policies for large and/or changing digital action spaces.

Additionally, the off-policy embedding evaluation system provides improved accuracy when compared to conventional policy evaluation systems. In particular, the projected value metrics generated by the off-policy embedding evaluation system estimate the value of target policy performance within digital action spaces more accurately than the projection metrics generated under conventional policy evaluation systems. Having metrics that better indicate the value of target policies within digital action spaces, the off-policy embedding evaluation system can employ improved policies that are well suited to operate within those digital action spaces. Thus, the off-policy embedding evaluation system allows for the improved accuracy of downstream applications that rely on these policies.

Further, the off-policy embedding evaluation system offers improved efficiency when compared to conventional policy evaluation systems. For example, by utilizing action embedding vectors that summarize digital actions, the off-policy embedding evaluation system reduces the amount of data processed in evaluating a target policy. Further, by estimating a density ratio of a target policy to a logging policy using samples of digital actions, the off-policy embedding evaluation system avoids the computationally expensive process of interacting with client devices via thousands to millions of back-and-forth internet communications to collect data under the logging policy. Thus, the off-policy embedding evaluation system reduces the amount of computing resources and computer processing time required to estimate the performance of a target policy.

As illustrated by the foregoing discussion, the present disclosure utilizes a variety of terms to describe features and benefits of the off-policy embedding evaluation system. Additional detail is now provided regarding the meaning of these terms. For example, as used herein, the term “digital action” refers to an action that can be performed within a digital environment. In particular, in some embodiments, a digital action refers to an action that can be performed (e.g., selected) by a digital system. For example, in some cases, a digital action includes a recommendation that can be provided by a recommendation system. To illustrate, in some implementations, a digital action includes a recommendation of digital content, such as a recommendation of a particular digital content item or a set (e.g., a slate) of digital content items. In some instances, a digital action includes a ranking of digital content items. For instance, in one or more embodiments, where a recommendation system recommends a set of digital content items, a digital action includes the recommendation of the digital content items and/or the particular ranking of the digital content items. A digital action, however, is not limited to the context of digital content items. For instance, in some cases, a digital action includes a recommendation of an action to be performed by a computing device or by a user of the computing device (e.g., a physical or digital location to visit).

Additionally, as used herein, the term “digital content” refers to digital data that can be viewed, listened to, interacted with, or otherwise consumed via a computing device. To illustrate, in some embodiments, digital content includes, but is not limited to, digital images, digital documents (e.g., text documents), digital music or other audio, digital advertising content, digital videos, digital webpages, or links to such. A digital content item includes a unit of digital content, such as a digital image, a digital document, an audio recording, a digital advertisement, a digital video, a digital webpage, or a link to such.

Further, as used herein, the term “digital action space” refers to a set of available digital actions. In particular, in some embodiments, a digital action space refers to a finite set of digital actions that can be performed. In some cases, a digital action space only includes digital actions of a particular type. For example, in some cases, a digital action space includes a set of digital images that can be recommended (e.g., a digital image dataset). In some implementations, however, a digital action space includes digital actions of various types that can be performed according to a policy, such as a logging policy or a target policy.

As used herein, the term “policy” refers to a computer-implemented model or algorithm for performing (e.g., selecting, generating, ranking, displaying) digital actions represented within a digital action space. In particular, in some embodiments, a policy refers to a model or algorithm that selects which digital action is performed at a given point in time. For instance, in some cases, a policy includes a recommendation policy that selects one or more digital content items for recommendation at a given point in time. As another example, in some implementations, a policy includes a ranking policy that determines a ranking of a set of digital content items to be recommended. As used herein, the term “target policy” refers to a policy that is targeted for deployment and that controls, guides, or regulates digital actions represented within a digital action space. For instance, in some cases, a target policy includes a policy being evaluated for implementation within a digital action space. Further, as used herein, the term “logging policy” refers to a policy that was previously deployed and that controlled, guided, or regulated digital actions represented within a digital action space. For instance, in some cases, a logging policy includes a policy that is currently implemented within a digital action space.

In one or more embodiments, a policy selects a digital action based on a context. As used herein, the term “context” refers to an input of a policy. In particular, in some embodiments, a context refers to data or information used by a policy to make a selection of a digital action. For example, in some cases, a context includes a query (e.g., a search query). In some instances, a context includes the current state of the environment in which the policy operates or the past states of the environment.

As used herein, the term “unobserved digital action” is used with respect to a policy and refers to a digital action that is not (or has not yet been) performed with respect to that policy. Indeed, in some cases, reference to a digital action being unobserved under a policy means that the digital action has not been performed (e.g., selected) under that policy. For instance, in some cases, an unobserved digital action for a recommendation policy that recommends digital content includes a digital content item that has not been recommended under that policy. In some cases, a digital action has a zero percent chance of being performed under a policy, so it remains unobserved under that policy. In some cases, a digital action includes a newly added digital action within the digital action space, so the digital action is unobserved under a policy because the policy has not had the opportunity to perform the digital action.

Similarly, as used herein, the term “observed digital action” is used with respect to a policy and refers to a digital action that has been or can be performed under that policy. Indeed, in some cases, reference to a digital action being observed under a policy means that the digital action has been performed (e.g., selected) under that policy. In some instances, an observed digital action includes a digital action that has not yet been performed by a digital policy but has a non-zero percent chance of being performed under that policy (e.g., the digital action is observable under the policy). As the qualification of a digital action as unobserved or observed depends on the policy, a digital action that is unobserved under one policy may be observed under another policy.

As used herein, the term “attribute” (or “attribute of a digital action”) includes a characteristic or feature of a digital action. In particular, in some embodiments, an attribute of a digital action includes a patent or latent characteristic of a digital action. For instance, in some implementations, where a digital action includes a recommendation of a digital image, an attribute of the digital action can include, but is not limited to, a person or object portrayed in the digital image, a classification of the digital image, a resolution of the digital image, an origin of the digital image, a device used to capture the digital image, or a time at which the digital image was taken.

Additionally, as used herein, the term “action embedding vector” refers to a vector that encodes a digital action. In particular, in some embodiments, an action embedding vector includes a vector having values that summarize attributes (e.g., latent and/or patent attributes) of a digital action. Indeed, in some embodiments, an action embedding vector includes a dimensionality (e.g., a data size) that is lower than the dimensionality of the digital action itself. Accordingly, in some cases, the dimensions of an action embedding vector (e.g., the size of the vector) provide a condensed or compressed representation of the corresponding digital action.

Further, as used herein, the term “embedding space” refers a space in which digital data is embedded. In particular, in some embodiments, an embedding space refers to a space (e.g., a mathematical or numerical space) in which some representation of digital data (referred to as an embedding) exists. For example, in some implementations, an embedding space includes a dimensionality associated with a representation of digital data, including the number of dimensions associated with the representation and/or the types of dimensions. In one or more embodiments, an embedding space includes space in which action embedding vectors exist. Further, in some cases, an embedding space includes a space in which context embeddings exist. In some implementations, an embedding space includes a continuous space.

As used herein, the term “embedding model” refers to a computer-implemented model or algorithm that generates embeddings. In particular, in some embodiments, an embedding model refers to a computer-implemented model that analyzes an input and outputs a corresponding embedding based on the analysis. For instance, in some cases, an embedding model includes a computer-implemented model that generates an action embedding vector from a digital action. In some implementations, an embedding model generates a context embedding from a context. In some implementations, an embedding model includes a machine learning model, such as a neural network.

As used herein, the term “neural network” refers to a type of machine learning model, which can be tuned (e.g., trained) based on inputs to approximate unknown functions used for generating the corresponding outputs. In particular, in some embodiments, a neural network refers to a model of interconnected artificial neurons (e.g., organized in layers) that communicate and learn to approximate complex functions and generate outputs based on a plurality of inputs provided to the model. In some instances, a neural network includes one or more machine learning algorithms. Further, in some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial neural network, a graph neural network, or a multi-layer perceptron. In some embodiments, a neural network includes a combination of neural networks or neural network components.

As used herein, the term “projected performance” refers to an estimated performance of a target policy. In particular, in some embodiments, a projected performance refers to an estimated performance of a target policy within a digital action space. For instance, in some cases, a projected performance includes the estimated value of the digital actions performed by the target policy based on given contexts (e.g., the estimated rewards resulting from those digital actions).

Additionally, as used herein, the term “projected value metric” refers to a metric that indicates a projected performance of a target policy within a digital action space. In particular, in some embodiments, a projected value metric refers to a quantified measure of a target policy's projected performance. For example, in some instances, a projected value metric refers to a quantity that projects the rewards that will be obtained in response to digital actions performed by the target policy.

Further, as used herein, the term “density ratio” refers to a ratio that compares the densities of two policies. In particular, in some embodiments, a density ratio refers to a ratio that compares the densities of digital actions or some other aspects of a target policy and a logging policy. For instance, in some cases, a density ratio compares the densities of digital actions performed under the target policy and the logging policy. In some instances, a density ratio utilizes action embedding vectors and/or query embeddings to compare the densities.

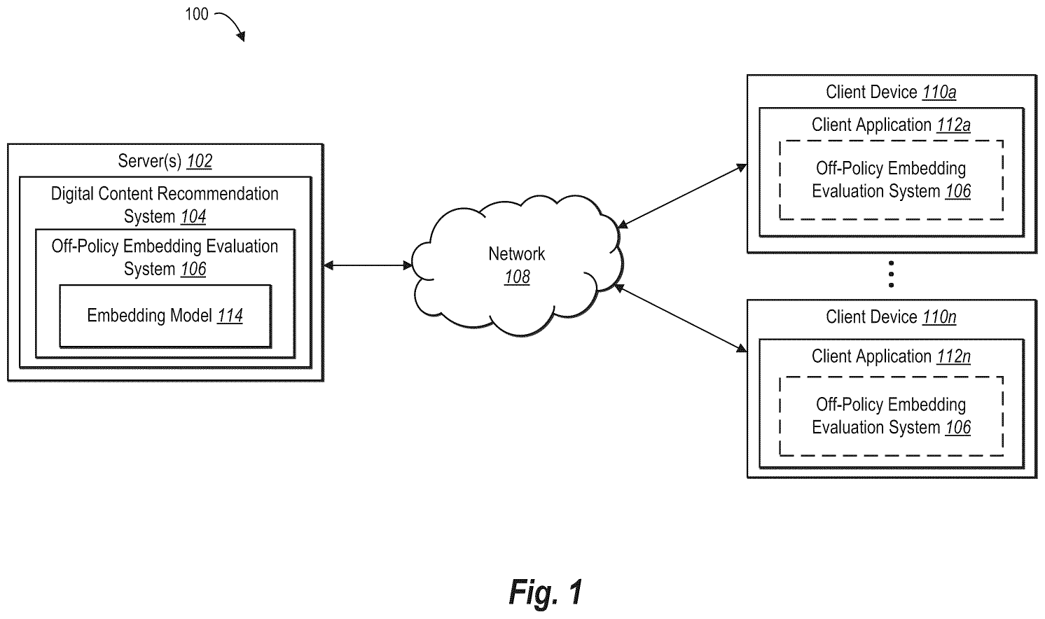

Additional detail regarding the off-policy embedding evaluation system will now be provided with reference to the figures. For example, FIG. 1 illustrates a schematic diagram of an exemplary system environment (“environment”) 100 in which an off-policy embedding evaluation system 106 operates. As illustrated in FIG. 1, the environment 100 includes a server(s) 102, a network 108, and client devices 110a-110n.

Although the environment 100 of FIG. 1 is depicted as having a particular number of components, the environment 100 is capable of having any number of additional or alternative components (e.g., any number of servers, client devices, or other components in communication with the off-policy embedding evaluation system 106 via the network 108). Similarly, although FIG. 1 illustrates a particular arrangement of the server(s) 102, the network 108, and the client devices 110a-110n, various additional arrangements are possible.

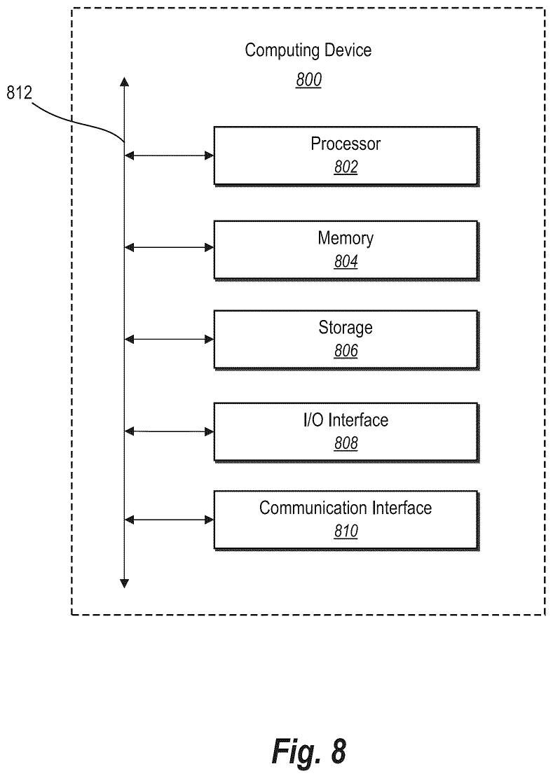

The server(s) 102, the network 108, and the client devices 110a-110n are communicatively coupled with each other either directly or indirectly (e.g., through the network 108 discussed in greater detail below in relation to FIG. 8). Moreover, the server(s) 102 and the client devices 110a-110n include one of a variety of computing devices (including one or more computing devices as discussed in greater detail with relation to FIG. 8).

As mentioned above, the environment 100 includes the server(s) 102. In one or more embodiments, the server(s) 102 generates, stores, receives, and/or transmits digital data including computer-implemented models and/or recommendations (e.g., recommendations that include digital content). In one or more embodiments, the server(s) 102 comprises a data server. In some implementations, the server(s) 102 comprises a communication server or a web-hosting server.

As shown in FIG. 1, the server(s) 102 includes a digital content recommendation system 104. In one or more embodiments, the digital content recommendation system 104 generates and provides recommendations to other computing devices (e.g., the client devices 110a-110n). In some embodiments, the digital content recommendation system 104 generates and provides a recommendation based on some context (e.g., in response to receiving a query from one of the client devices 110a-110n). In some cases, the digital content recommendation system 104 generates and provides digital content recommendations. For instance, in some cases, the digital content recommendation system 104 includes an image recommendation system that recommends digital images. In some cases, the digital content recommendation system 104 includes a search engine that retrieves and provides search results (e.g., ranked search results). In some cases, the digital content recommendation system 104 employs a policy, such as a recommendation policy and/or a ranking policy in generating recommendations.

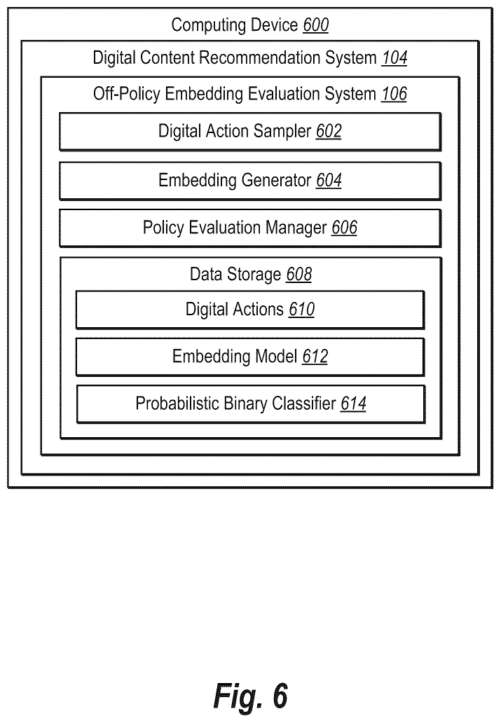

Additionally, the server(s) 102 include the off-policy embedding evaluation system 106. In one or more embodiments, the off-policy embedding evaluation system 106, via the server(s) 102, determines the projected performance of a target policy within a digital action space. For example, in some embodiments, via the server(s) 102, the off-policy embedding evaluation system 106 generates action embedding vectors (e.g., using an embedding model 114) for digital actions within the digital action space. Via the server(s) 102, the off-policy embedding evaluation system 106 further generates a projected value metric for the target policy using the action embedding vectors. Example components of the off-policy embedding evaluation system 106 will be described below with reference to FIG. 6.

In one or more embodiments, the client devices 110a-110n include computing devices that are capable of performing, receiving, and/or displaying digital actions. For example, the client devices 110a-110n include one or more of smartphones, tablets, desktop computers, laptop computers, head-mounted-display devices, and/or other electronic devices. In some instances, the client devices 110a-110n include one or more applications (e.g., the client applications 112a-112n, respectively) that are capable of performing, receiving, and/or displaying digital actions. For example, in one or more embodiments, the client applications 112a-112n include a software application installed on the client devices 110a-110n, respectively. Additionally, or alternatively, the client applications 112a-112n include a software application hosted on the server(s) 102 (and supported by the digital content recommendation system 104), which is accessible by the client devices 110a-110n, respectively, through another application, such as a web browser.

The off-policy embedding evaluation system 106 can be implemented in whole, or in part, by the individual elements of the environment 100. Indeed, as shown in FIG. 1 the off-policy embedding evaluation system 106 can be implemented with regard to the server(s) 102 and/or at the client devices 110a-110n. In particular embodiments, the off-policy embedding evaluation system 106 on the client devices 110a-110n comprises a web application, a native application installed on the client devices 110a-110n (e.g., a mobile application, a desktop application, a plug-in application, etc.), or a cloud-based application where part of the functionality is performed by the server(s) 102.

In additional or alternative embodiments, the off-policy embedding evaluation system 106 on the client devices 110a-110n represents and/or provides the same or similar functionality as described herein in connection with the off-policy embedding evaluation system 106 on the server(s) 102. In some implementations, the off-policy embedding evaluation system 106 on the server(s) 102 supports the off-policy embedding evaluation system 106 on the client devices 110a-110n.

For example, in some embodiments, the off-policy embedding evaluation system 106 on the server(s) 102 train one or more machine learning models described herein (e.g., the embedding model 114). The off-policy embedding evaluation system 106 on the server(s) 102 provides the one or more trained machine learning models to the off-policy embedding evaluation system 106 on the client devices 110a-110n for implementation. Accordingly, although not illustrated, in one or more embodiments the client devices 110a-110n utilize the one or more trained machine learning models to generate recommendations.

In some embodiments, the off-policy embedding evaluation system 106 includes a web hosting application that allows the client devices 110a-110n to interact with content and services hosted on the server(s) 102. To illustrate, in one or more implementations, the client devices 110a-110n accesses a web page or computing application supported by the server(s) 102. The client devices 110a-110n provide input to the server(s) 102 (e.g., a query). In response, the off-policy embedding evaluation system 106 on the server(s) 102 utilizes the trained machine learning models to generate a recommendation. The server(s) 102 then provides the recommendation to the client devices 110a-110n.

In some embodiments, though not illustrated in FIG. 1, the environment 100 has a different arrangement of components and/or has a different number or set of components altogether. For example, in certain embodiments, the client devices 110a-110n communicate directly with the server(s) 102, bypassing the network 108. As another example, the environment 100 includes a third-party server comprising a content server and/or a data collection server.

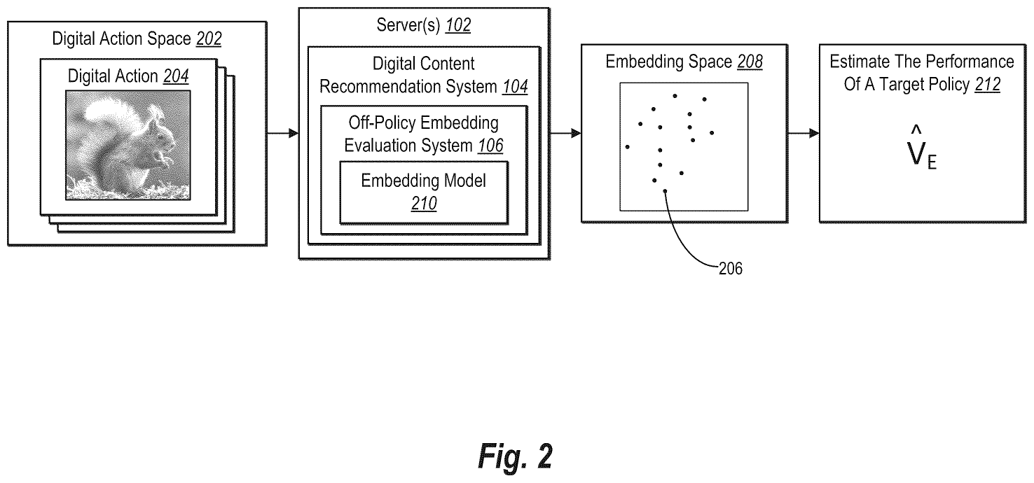

As mentioned above, the off-policy embedding evaluation system 106 determines a projected performance of a target policy utilizing action embedding vectors that represent digital actions of a digital action space. FIG. 2 illustrates an overview diagram of the off-policy embedding evaluation system 106 predicting the performance of a target policy using action embedding vectors in accordance with one or more embodiments.

As shown in FIG. 2, the off-policy embedding evaluation system 106 estimates the performance of a target policy with respect to a digital action space 202. In particular, the off-policy embedding evaluation system 106 estimates the value of the target policy operating within the digital action space 202. Indeed, as illustrated by FIG. 2, the digital action space 202 includes a set of digital actions, such as the digital action 204 (e.g., shown as a digital image that can be selected for recommendation). Accordingly, in one or more embodiments, the off-policy embedding evaluation system 106 estimates the performance of the target policy by predicting the value obtained as the target policy performs digital actions from the digital action space 202 (e.g., recommends digital images).

As further shown in FIG. 2, the off-policy embedding evaluation system 106 generates action embedding vectors from the digital actions of the digital action space, such as the action embedding vector 206. Indeed, as shown, the off-policy embedding evaluation system 106 generates the action embedding vectors within an embedding space 208. In some cases, the off-policy embedding evaluation system 106 generates an action embedding vector for every digital action from the digital action space 202. In some cases, however, the off-policy embedding evaluation system 106 generates action embedding vectors for a subset of the digital actions from the digital action space 202. For instance, in some cases, the off-policy embedding evaluation system 106 generates action embedding vectors for one or more sets of sampled digital actions from the digital action space 202 as will be discussed in more detail below.

As indicated in FIG. 2, the off-policy embedding evaluation system 106 utilizes an embedding model 210 to generate the action embedding vectors. For instance, in some cases, the off-policy embedding evaluation system 106 utilizes the embedding model 210 to analyze the digital actions from the digital action space 202 and generate the action embedding vectors based on the analysis.

In some cases, the embedding model 210 includes a model that is capable of generating action embedding vectors for the type of digital action being analyzed. For instance, where the digital actions include digital images, the embedding model 210 includes a model that can analyze and generate action embedding vectors from digital images. In some cases, the embedding model 210 includes a multi-modal model that is capable of generating action embedding vectors for various types of digital actions. In one or more embodiments, the off-policy embedding evaluation system 106 utilizes, as the embedding model 210, the multi-domain style encoder or one of its model components in U.S. patent application Ser. No. 17/652,390 filed on Feb. 24, 2022, entitled GENERATING ARTISTIC CONTENT FROM A TEXT PROMPT OR A STYLE IMAGE UTILIZING A NEURAL NETWORK MODEL, the contents of which are expressly incorporated herein by reference in their entirety.

As further shown in FIG. 2, the off-policy embedding evaluation system 106 performs an act 212 of estimating the performance of the target policy. In particular, the off-policy embedding evaluation system 106 determines a projected performance of the target policy using the action embedding vectors within the embedding space 208. To provide more detail, in one or more embodiments, the off-policy embedding evaluation system 106 determines the projected performance by estimating the value of the target policy as follows:

V(π)= [symbol] _{c}[ [symbol] _{π}_{₁}[ [symbol] [Y|A,C]]] (1)

In function 1, Y˜p (Y|A,C) represents a binary reward distributed as p. The off-policy embedding evaluation system 106 can define the reward using various outcomes that are targeted as a result of a digital actions. For instance, in some cases, the off-policy embedding evaluation system 106 defines the reward as a targeted response to a recommendation (e.g., a click, a view, a purchase, or some other interaction with the recommendation).

In one or more embodiments, the off-policy embedding evaluation system 106 defines [symbol] to be the set of all possible digital actions (i.e., the digital action space), denotes the target policy as π₁(A|C), and denotes a logging policy that will be used in evaluating the target policy as π₀(A|C). Further, the off-policy embedding evaluation system 106 uses [symbol] to denote the set of m available contexts and denotes the distribution of contexts as p ( [symbol] ).

Further, in some embodiments, the off-policy embedding evaluation system 106 defines the distribution of data under the logging policy being used as p₀=p₀ (Y, A, C)=p (Y|A, C)π₀(A|C)p(C). Similarly, the off-policy embedding evaluation system 106 defines the distribution of data under the target policy as p₁=p₁(Y, A, C)=p (Y|A, C)π₁ (A|C)p(C).

Additionally, in one or more embodiments, the off-policy embedding evaluation system 106 observes data as tuples (C, A, Y)ᵢ₌₁^{N}, generated under the logging policy p₀ (Y, A, C). Further, in some cases, the off-policy embedding evaluation system 106 denotes the set of observed digital actions under the logging policy π₀ as [symbol] ₀ with d₀=| [symbol] ₀| and likewise for the target policy π₁.

In one or more embodiments, the off-policy embedding evaluation system 106 determines the projected performance of a target policy by generating a projected value metric for the target policy. To illustrate, in some implementations, the off-policy embedding evaluation system 106 utilizes inverse propensity score (IPS) weighting to generate the projected value metric. For instance, in some cases, the off-policy embedding evaluation system 106 observes digital actions performed under the logging policy

$${π}_{0}^{obs} ( A = a \vert C = c ) ≡ \frac{{\sum }_{i = 1}^{N} I ( {A}_{i} = a , {C}_{i} = c )}{{\sum }_{i = 1}^{N} I ( {C}_{i} = c )} .$$

In some embodiments, when the target policy density is known, the off-policy embedding evaluation system 106 generates the projected value metric for the target policy as follows:

$${\hat{V}}_{IPS} = \frac{1}{N} {\sum }_{i = 1}^{N} {Y}_{i} \frac{{π}_{1} ( {A}_{i} \vert {C}_{i} )}{{π}_{0}^{obs} ( {A}_{i} \vert {C}_{i} )} \qquad ( 2 )$$

In one or more embodiments, if A and C are discrete, so is the estimator π₀^{obs}. Accordingly, \hat{V}_{IPS} will also be consistent. In some cases, the off-policy embedding evaluation system 106 stabilizes the weights by dividing by the sum of the weights as follows:

$${\hat{V}}_{IPSS} = \frac{\frac{1}{N} {\sum }_{i = 1}^{N} {Y}_{i} \frac{{π}_{1} ( {A}_{i} \vert {C}_{i} )}{{π}_{0}^{obs} ( {A}_{i} \vert {C}_{i} )}}{\frac{1}{N} {\sum }_{i = 1}^{N} \frac{{π}_{1} ( {A}_{i} \vert {C}_{i} )}{{π}_{0}^{obs} ( {A}_{i} \vert {C}_{i} )}} \qquad ( 3 )$$

Thus, in some cases, the off-policy embedding evaluation system 106 estimates the value of a target policy (e.g., generates a projected value metric for the target policy) using raw digital actions rather than action embedding vectors that represent those digital actions. As discussed above, however, where digital actions performed by the logging policy and digital actions performed by the target policy differ (i.e., [symbol] ₀≠ [symbol] ₁), absolute continuity is violated and digital actions that were unobserved under the logging policy are not handled with accuracy.

Accordingly, as discussed above, in some embodiments, the off-policy embedding evaluation system 106 utilizes action embedding vectors to represent digital actions within a continuous space. Indeed, as mentioned above, in some cases, the off-policy embedding evaluation system 106 generates action embedding vectors for digital actions using the embedding model 210. In one or more embodiments, the off-policy embedding evaluation system 106 represents the embedding model 210 as a map g: A∈ [symbol] →g(A; β_{A})∈[0,1]^{q}, which is a function parameterized by P A that takes a digital action and represents it as a point within a bounded space (e.g., the embedding space 208). In one or more embodiments, the off-policy embedding evaluation system 106 determines that the embedding space 208 is useful for evaluating the target policy such that:

$${\int }_{A} {\sum }_{C , Y} 𝔼 [ Y \vert A , C ] {π}_{1} ( A \vert C ) p ( C ) = {\int }_{A} {\sum }_{C , Y} 𝔼 [ Y \vert g ( A ) , C ] {π}_{1} ( g ( A ) \vert C ) p ( C ) \qquad ( 4 )$$

In some embodiments, relying on function 4, the off-policy embedding evaluation system 106 determines that the potential outcome of the reward under a hypothetical action a is equal to the observed reward when A=a (i.e., Y (a) is equal to Y when A=a). Additionally, in some implementations the off-policy embedding evaluation system 106 determines that π₁(g (A)|C)>0⇒π₀(g (A)|C)>0 and/or that the potential outcome of the reward under a hypothetical action Y(a) is independent of the actual action A given the context C.

Thus, as discussed above, in some embodiments, the off-policy embedding evaluation system 106 utilizes action embedding vectors to determine the value of a target policy within a digital action space. In particular, in some embodiments, the off-policy embedding evaluation system 106 uses action embedding vectors to generate a projected value metric for the target policy. For instance, in some cases, the off-policy embedding evaluation system 106 generates the projected value metric for the target policy using action embedding vectors by modifying function 2 as follows:

$${\hat{V}}_{E} = \frac{1}{N} {\sum }_{i = 1}^{N} {Y}_{i} \frac{{π}_{1} ( g ( {A}_{i} ) \vert {C}_{i} )}{{π}_{0} ( g ( {A}_{i} ) \vert {C}_{i} )} \qquad ( 5 )$$

Thus, in one or more embodiments, the off-policy embedding evaluation system 106 encodes digital actions from a digital action space. In particular, the off-policy embedding evaluation system 106 encodes the digital actions by generating action embedding vectors that represent the digital actions. Accordingly, in one or more embodiments, the algorithm and acts described with reference to FIG. 2 comprise the corresponding structure for performing a step for encoding the set of digital actions into a set of action embedding vectors.

By utilizing action embedding vectors to evaluate a target policy, the off-policy embedding evaluation system 106 operates with improved flexibility when compared to conventional policy evaluation systems. Indeed, the off-policy embedding evaluation system 106 can more flexibly estimate the performance of target policies within digital action spaces. In particular, by utilizing action embeddings within an embedding space (e.g., a continuous space) to evaluate a target policy, the off-policy embedding evaluation system 106 can evaluate target policies that violate absolute continuity. In other words, the off-policy embedding evaluation system 106 can evaluate target policies that may perform digital actions that were unobserved under a logging policy.

Further, utilizing action embedding vectors provides improved efficiency when compared to conventional policy evaluation systems. In particular, by utilizing action embedding vectors to evaluate a target policy, the off-policy embedding evaluation system 106 reduces the computing resources required for the evaluation. Indeed, as the action embedding vectors summarize attributes of the corresponding digital actions with a lower dimensionality, the off-policy embedding evaluation system 106 reduces the size of the data processed to perform the evaluation.

As shown in function 5, in some embodiments, the off-policy embedding evaluation system 106 utilizes a density ratio of a target policy π₁ to a logging policy π₀ to generate a projected value metric for the target policy. In some cases, the off-policy embedding evaluation system 106 utilizes function 5 directly to generate the projected value metric. For instance, in some cases, the off-policy embedding evaluation system 106 determines the densities of the logging policy and the target policy and uses the densities in the density ratio. Thus, in some embodiments, the off-policy embedding evaluation system 106 generates the projected value metric for the target policy in accordance with function 5 using data from the logging policy (Yᵢ, g (Aᵢ), Cᵢ)ᵢ₌₁^{N}.

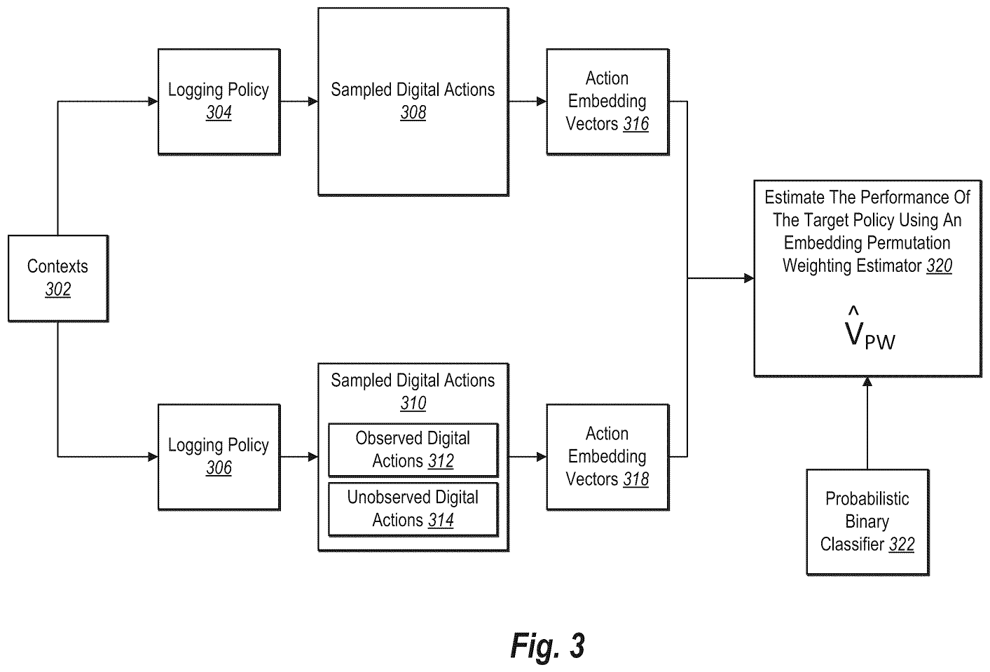

In some embodiments, however, rather than determining the density ratio by using the densities of the logging and target policies, the off-policy embedding evaluation system 106 estimates the density ratio and generates the projected value metric using the estimated density ratio. FIG. 3 illustrates a diagram for generating a projected value metric for a target policy using an estimated density ratio in accordance with one or more embodiments.

As shown in FIG. 3, the off-policy embedding evaluation system 106 utilizes a set of contexts 302 to generate a set of sampled digital actions 308 from the logging policy 304. Further, the off-policy embedding evaluation system 106 utilizes the set of contexts 302 to generate a set of sampled digital actions 310 from the target policy 306. In one or more embodiments, the off-policy embedding evaluation system 106 utilizes the same contexts from the set of contexts 302 to generate the samples from both the logging policy 304 and the target policy 306.

As shown in FIG. 3, the set of sampled digital actions 310 generated from the target policy 306 include observed digital actions 312 and unobserved digital actions 314. In particular, the observed digital actions 312 includes observed digital actions under the logging policy 304, and the unobserved digital actions 314 include unobserved digital actions under the logging policy 304. In other words, the samples generated from the target policy 306 can include digital actions that were never performed under the logging policy 304 as the target policy 306 may make a different selection for a given context. It should be noted that, although FIG. 3 shows the set of sampled digital actions 310 having both observed and unobserved digital actions with respect to the logging policy, some embodiments include only observed digital actions or unobserved digital actions.

As further illustrated by FIG. 3, the off-policy embedding evaluation system 106 generates action embedding vectors 316 for the set of sampled digital actions 308 generated from the logging policy 304. Similarly, the off-policy embedding evaluation system 106 generates action embedding vectors 318 for the set of sampled digital actions 310 generated from the target policy 306.

While FIG. 3 shows a sequence of generating sampled digital actions and then generating action embedding vectors for the sampled digital actions, it should be known that the off-policy embedding evaluation system 106 generates action embedding vectors and samples from the action embedding vectors in some instance. For example, in some embodiments, the off-policy embedding evaluation system 106 generates action embedding vectors for every digital action within a digital action space and samples from the action embedding vectors for the logging policy 304 and the target policy 306. For instance, in some cases, the off-policy embedding evaluation system 106 maintains (e.g., stores) action embedding vectors for the digital actions and accesses the stored action embedding vectors to evaluate target policies. Thus, the off-policy embedding evaluation system 106 avoids generating action embedding vectors for the same digital actions when evaluating multiple target policies for the same digital action space.

To provide one example, in some cases, the off-policy embedding evaluation system 106 generates action embedding vectors for the digital actions of a digital action space. The off-policy embedding evaluation system 106 further generates context embeddings for the contexts 302. In particular, the off-policy embedding evaluation system 106 generates the context embeddings within the same embedding space as the action embedding vectors. Accordingly, in some implementations, the off-policy embedding evaluation system 106 utilizes the logging policy 304 and/or the target policy 306 to generate sample digital actions based on the proximity of context embeddings and action embedding vectors within the common embedding space.

As further shown in FIG. 3, the off-policy embedding evaluation system 106 performs an act 320 of estimating the performance of the target policy 306 using an embedding permutation weighting estimator. In particular, the off-policy embedding evaluation system 106 generates a projected value metric for the target policy 306 using the embedding permutation weighting estimator. As shown in FIG. 3, the off-policy embedding evaluation system 106 utilizes the action embedding vectors from the logging policy 304 and the target policy 306 in defining the embedding permutation weighting estimator as follows:

$${\hat{V}}_{P W} = \frac{1}{N h} {\sum }_{i = 1}^{N} {Y}_{i} w ( g ( {A}_{i} ) , g ( {A}_{i}^{′} ) , {C}_{i} ) K ( \frac{g ( {A}_{i}^{′} ) - g ( {A}_{i} )}{h} ) \qquad ( 6 )$$

In one or more embodiments, the off-policy embedding evaluation system 106 represents the samples from the logging policy 304 as (g(Aᵢ), Cᵢ)ᵢ₌₁^{N} and represents the samples from the target policy 306 as (g (Aᵢ′), Cᵢ)ᵢ₌₁^{N} where Aᵢ and Aᵢ′ represent the sampled digital actions under those policies, respectively. Thus, in function 6, (g (Aᵢ), g(Aᵢ′), Cᵢ) represents the action embedding vectors g (Aᵢ) and g (Aᵢ′) generated from the logging policy 304 and the target policy 306, respectively, based on the context Cᵢ. As such

$$w ( g ( {A}_{i} ) , g ( {A}_{i}^{′} ) , {C}_{i} ) = \frac{{π}_{1} ( g ( {A}_{i} ) \vert {C}_{i} )}{{π}_{0} ( g ( {A}_{i} ) \vert {C}_{i} )}$$

is the density ratio of the target policy 306 to the logging policy 304. Further, in function 6, K represents some kernel (e.g., the radial basis function kernel) and h represents the bandwidth of the kernel (e.g., selected via a median distance heuristic).

As shown in FIG. 3, the off-policy embedding evaluation system 106 further utilizes a probabilistic binary classifier 322 in implementing the embedding permutation weighting estimator to generate the projected value metric for the target policy 306. Indeed, in one or more embodiments, the off-policy embedding evaluation system 106 utilizes function 6 to recast the density ratio estimation problem of function 5 into a binary probabilistic classification problem.

To illustrate, in one or more embodiments, the off-policy embedding evaluation system 106 utilizes Z=0 to represent samples (g (Aᵢ), Cᵢ)ᵢ₌₁^{N} generated from the logging policy 304 and Z=1 to represent samples (g (Aᵢ′), Cᵢ)ᵢ₌₁^{N} generated from the target policy 306. In some cases, the probabilistic binary classifier 322 has features g (A)⊗C and labels Z=0,1. In other words, in one or more embodiments, the off-policy embedding evaluation system 106 utilizes the probabilistic binary classifier 322 to classify a digital action for a given input as being generated from the logging policy 304 or the target policy 306.

In one or more embodiments, the off-policy embedding evaluation system 106 fits (e.g., pre-trains) the probabilistic binary classifier 322 to classify digital actions. For example, in some cases, the off-policy embedding evaluation system 106 utilizes the probabilistic binary classifier 322 to predict classifications for training digital actions based on given contexts. Further, the off-policy embedding evaluation system 106 utilizes annotations (e.g., labels indicating the policy that performed the digital action) to determine an error of the probabilistic binary classifier 322. In some cases, the off-policy embedding evaluation system 106 utilizes the determined error to modify parameters of the probabilistic binary classifier 322. Over several iterations, the off-policy embedding evaluation system 106 reduces the error so that the probabilistic binary classifier 322 can distinguish between policy outcomes.

In one or more embodiments, the off-policy embedding evaluation system 106 utilizes the probabilistic binary classifier 322 to recover η=p (Z=1|g (A)⊗C), with estimate \hat{η}. Accordingly, in some embodiments, the off-policy embedding evaluation system 106 determines the importance sampling weight w=π₁/π₀ as follows:

$$\begin{matrix}w ( g ( A ) , C ) = \frac{η ( g ( A ) , C )}{1 - η ( g ( A ) , C )} \\ = \frac{p ( Z = 1 \vert ( A ) , C )}{( Z = 0 \vert ( A ) , C )} \\ = \frac{p ( g ( A ) , C \vert Z = 1 ) p ( Z = 1 ) p ( g ( A ) , C )}{p ( g ( A ) , C \vert Z = 0 ) p ( Z = 0 ) p ( g ( A ) , C )} \\ = \frac{{π}_{1} ( g ( A ) , C ) p ( C )}{{π}_{0} ( g ( A ) , C ) p ( C )} \\ = \frac{{π}_{1} ( g ( A ) , C )}{{π}_{0} ( g ( A ) , C )}\end{matrix} \qquad ( 7 )$$

Thus, in accordance with function 7, the off-policy embedding evaluation system 106 utilizes the probabilistic binary classifier 322 to estimate the density ratio. Put differently, in one or more embodiments, the off-policy embedding evaluation system 106 generates sampled digital actions from the target policy and the logging policy. The off-policy embedding evaluation system 106 further utilizes the probabilistic binary classifier 322 to predict which policy a particular sampled digital action is from (e.g., generate a probability that the sampled digital action comes from one of the policies). The off-policy embedding evaluation system 106 utilizes these predictions from the probabilistic binary classifier 322 to estimate the density ratio of the target policy to the logging policy.

In one or more embodiments, if the sampling weight is evaluated at different values of A for the logging policy 304 and the target policy 306, the off-policy embedding evaluation system 106 defines the following:

$$w ( g ( {A}_{i} ) , g ( {A}_{i}^{′} ) , {C}_{i} ) = \frac{{π}_{1} ( g ( {A}_{i}^{′} ) , C )}{{π}_{0} ( g ( {A}_{i} ) , C )} = \frac{η ( g ( {A}_{i}^{′} ) , C )}{1 - η ( g ( {A}_{i} ) , C )} \qquad ( 8 )$$

In one or more embodiments, the off-policy embedding evaluation system 106 utilizes, to determine the estimate the density ratio of the target policy to the logging policy (e.g., to determine the embedding permutation weighting estimator of function 6), the permutation weighting method described by David Arbour et al., Permutation Weighting, ICML, p. 11, 2021, which is incorporated herein by reference in its entirety.

By utilizing sampled digital actions to evaluate a target policy, the off-policy embedding evaluation system 106 operates with improved efficiency when compared to conventional policy evaluation systems. Indeed, where conventional policy evaluation systems may spend weeks or months collecting observed data via thousands or millions of back-and-forth internet communications, the off-policy embedding evaluation system 106 generates one or more sets of sampled digital actions and performs the evaluations accordingly. Thus, the off-policy embedding evaluation system 106 can reduce the time required in preparation for the evaluation and further reduce the amount of computing processing and network communications required for the evaluation.

In one or more embodiments, rather than using the embedding permutation weighting estimator shown by function 6, the off-policy embedding evaluation system 106 utilizes a different estimator for estimating the density ratio of the target policy to the logging policy. For instance, in some embodiments, the off-policy embedding evaluation system 106 utilizes the embedded g-formula estimator (e.g., also referred to as the direct method estimator) defined as follows:

$${\hat{V}}_{g} = \frac{1}{N} {\sum }_{i = 1}^{N} \hat{𝔼} [ Y \vert g ( {A}_{i}^{′} ) , {C}_{i} ] \qquad ( 9 )$$

In some cases, the off-policy embedding evaluation system 106 utilizes the estimator defined by function 9 for g(Aᵢ′) such that Aᵢ′˜π₁(A|Cᵢ), for i=1, . . . , N, and for [symbol] a regression model fitted on (Y, A, C)ᵢ₌₁^{N} from the logging distribution p₀(Y, A, C).

In some implementations, the off-policy embedding evaluation system 106 utilizes an embedded doubly robust estimator. In some cases, the embedded doubly robust estimator includes elements of both the embedded permutation weighting estimator and the embedded g-formula estimator. For instance, in some cases, the off-policy embedding evaluation system 106 defines the embedded doubly robust estimator as follows:

$${\hat{V}}_{D R} = \frac{1}{N} {\sum }_{i = 1}^{N} ( \hat{𝔼} [ Y \vert g ( {A}_{i}^{′} ) , {C}_{i} ] + ( {Y}_{i} - \hat{𝔼} [ Y \vert g ( {A}_{i}^{′} ) , {C}_{i} ] ) w ( g ( {A}_{i} ) , {C}_{i} ) \frac{1}{h} K ( \frac{g ( {A}_{i}^{′} ) - g ( {A}_{i} )}{h} ) ) \qquad ( 10 )$$

In function 10, g(Aᵢ′)˜π₁(A|Cᵢ) for i=1, . . . , N and the term w(g (Aᵢ), Cᵢ) is fitted as described above with reference to function 6. In one or more embodiments, the embedded doubly robust estimator attains a semiparametric efficiency bound.

In one or more embodiments, the off-policy embedding evaluation system 106 employs a target policy value. Indeed, in some cases, the off-policy embedding evaluation system 106 utilizes a target policy value to perform digital actions within a digital action space. For example, in some cases, the off-policy embedding evaluation system 106 employs a target policy within a digital action space based on an estimated value of the target policy value within the digital action space. To illustrate, in some cases, the off-policy embedding evaluation system 106 implements a target policy upon determining that a projected value metric for the target policy satisfies a threshold value. In some instances, the off-policy embedding evaluation system 106 implements a target policy upon determining that the projected value metric for the target policy is higher than a value of the current policy operating within the digital action space.

Thus, in some implementations, the off-policy embedding evaluation system 106 implements target policies based on their projected performance. Accordingly, the off-policy embedding evaluation system 106 can use a target policy within downstream applications, such as the provision of recommendations using the selections of a target policy and/or the provision of a ranked set of search results in response to a search query.

In some embodiments, the off-policy embedding evaluation system 106 evaluates characteristics of the estimator used in generating projected value metrics for target policies, such as the unbiasedness of the estimator. For instance, in one or more embodiments, the off-policy embedding evaluation system 106 determines that as the sample size approaches infinity (e.g., N→∞), the size of the sets of digital actions associated with each policy also approaches infinity (e.g., d₀, d₁→∞). To illustrate, in some cases, the logging and target policies include neural networks that take a context and return a random vector in the embedding space, which can be a latent representation of the digital action space. As such, in these cases, the sets of digital actions increase as the sample size increases. Accordingly, the off-policy embedding evaluation system 106 determines that the estimator is unbiased in this setting as it reduces to the case of off-policy evaluation with continuous digital action spaces.

Further, in some implementations, the off-policy embedding evaluation system 106 evaluates the unbiasedness of the estimator in scenarios with some fixed d₀, d₁ while N→∞. In some cases, this represents a common situation where the set of digital actions (e.g., the size of the database of images to be recommended) is finite. Consequently, the policies can only perform digital actions that exist, meaning that even when N→∞, the policies may fail to explore the entire embedding space. Accordingly, in some cases, the problem is undetermined as presented.

Thus, in some cases, the off-policy embedding evaluation system 106 considers the problem by utilizing [symbol] ⱼ^{N,d}(g (A), C) to denote the empirical distribution of observed digital actions in latent space for a digital action space of size d and sample size N in j=0,1 denoting source or target domains respectively. Further, the off-policy embedding evaluation system 106 defines an operator T: [symbol] × [symbol] →R where R denotes a density ratio. Accordingly, the off-policy embedding evaluation system 106 defines a continuous density ratio of digital actions in latent space that is derived from the two empirical distributions of observed digital actions as follows:

$${w}^{o b s} ( g ( A ) , C ) ≡ \frac{{π}_{1}^{o b s} ( g ( A ) \vert C )}{{π}_{0}^{o b s} ( g ( A ) \vert C )} ≡ T ( {𝔽}_{0}^{N , d} ( g ( A ) \vert C ) , {𝔽}_{1}^{N , d} ( g ( A ) \vert C ) ) \qquad ( 11 )$$

The operator in function 11 denotes an abstract method of obtaining a policy from the empirical distribution of observed digital actions. For instance, using the embedding permutation weighting estimator, the off-policy embedding evaluation system 106 obtains a density ratio estimate by considering empirical distributions [symbol] ₀^{N,d}(g (A)|C), [symbol] ₁^{N,d} (g(A)|C) from the source and target policies respectively. The off-policy embedding evaluation system 106 further fits a classifier η to distinguish between the source and target distributions. Additionally, the off-policy embedding evaluation system 106 utilizes the operator to return the ratio r (A, C)=η₁/η₀ as the density ratio estimate. For some d, as N→∞, the off-policy embedding evaluation system 106 determines the following:

$${w}^{o b s} ( g ( A ) , C ) = \frac{{π}_{1}^{o b s} ( g ( A ) \vert C )}{{π}_{0}^{o b s} ( g ( A ) \vert C )} \to \frac{{\tilde{π}}_{1} ( g ( A ) \vert C )}{{\tilde{π}}_{0} ( g ( A ) \vert C )} = \tilde{w} ( g ( A ) , C ) \qquad ( 12 )$$

In one or more embodiments, though \tilde{π}₁/\tilde{π}₀ generally does not equal π₁/π₀ the off-policy embedding evaluation system 106 extrapolates from an observed policy π^{obs}(g (A)|C) over a finite set of observations (in d₀ or d₁) to the underlying policy π(g (A)|C) over a continuous embedding space. In some cases, the off-policy embedding evaluation system 106 denotes this extrapolation as \tilde{π}(g (A)|C). Further, in some instances, the off-policy embedding evaluation system 106 defines the distribution \tilde{p} as p (Y|A, C)π(g (A)|C)p(C). At any finite d, it is not expected that the extrapolated policy converges to the underlying policy, even as N→∞. In some cases, this also holds true for the density ratio.

In some implementations, to analyze the impact of the difference between the extrapolated policy \tilde{π} and the true underlying policy π, the off-policy embedding evaluation system 106 utilizes the KL-divergence D (\tilde{π}∥π) as a measure of the discrepancy. Further, in some cases, the off-policy embedding evaluation system 106 determines that the discrepancy decreases as more digital actions are observed so that:

d→∞⇒D(\tilde{π}∥π)→0 (13)

In one or more embodiments, the off-policy embedding evaluation system 106 further determines a quadratic cost transportation inequality to link the KL-divergence of two distributions to the difference in the expectations of a random variable under each of those distributions. For instance, in some cases, using Z to represent a real-value integrable random variable and given v>0, the off-policy embedding evaluation system 106 determines that:

$$log 𝔼 [ exp ( λ ( Z - 𝔼 [ Z ] ) ) ] \leq \frac{v {λ}^{2}}{2} \qquad ( 14 )$$

In some cases, the off-policy embedding evaluation system 106 utilizes function 14 for every λ>0 if and only if, for any probability measure Q absolutely continuous with respect to P such that D(Q∥P)<∞ and the off-policy embedding evaluation system 106 determines the following:

[symbol]

_{Q}[Z]= [symbol] ₚ[Z]≤\sqrt{2vD(Q∥P)} (15)

In one or more implementations, the off-policy embedding evaluation system 106 further determines that there exists v₀>0 such that for all λ₀>0,

$$log 𝔼 [ exp ( λ ( {Yw}_{obs} - {𝔼}_{{\tilde{p}}_{0}} [ {Yw}_{obs} ] ) ) ] \leq \frac{{v}_{0} {λ}_{0}^{2}}{2} \qquad ( 16 )$$

In some cases, the off-policy embedding evaluation system 106 further determines that there exists v₁>0 such that for all λ₁>0,

$$log 𝔼 [ exp ( λ ( {( {Yw}_{obs} )}^{2} - {𝔼}_{{\tilde{p}}_{0}} [ {( {Yw}_{obs} )}^{2} ] ) ) ] \leq \frac{{v}_{1} {λ}_{1}^{2}}{2} \qquad ( 17 )$$

In some embodiments, using functions 14-17, the off-policy embedding evaluation system 106 derives the following bounds:

[symbol]

_{\tilde{p}}_{₀}[Yw_{obs}]+Eₚ_{₀}[Yw_{obs}]≤\sqrt{2v₀D(\tilde{π}₀∥π₀)} (18)

[symbol]

_{\tilde{p}}_{₀}[(Yw_{obs})²]+Eₚ_{₀}[(Yw_{obs})²]≤\sqrt{2v₁D(π₀∥π₀)} (19)

In some cases, by the chain property rule of KL-divergence, the off-policy embedding evaluation system 106 determines the following:

D(\tilde{p}∥p)=D(p(Y|A,c)∥p(Y|A,C))+D(\tilde{π}∥π)+D(p(C)∥p(C))=D(\tilde{π}∥π) (20)

As another example of evaluating characteristics of an estimator, in one or more embodiments, the off-policy embedding evaluation system 106 determines an error of the embedding permutation weighting estimator. Indeed, in some cases, the off-policy embedding evaluation system 106 determines that the bias of the estimator is the difference between the expectation of the estimator under the data against the parameter being estimated. Accordingly, in some cases, where the expectations are taken with respect to different distributions, the off-policy embedding evaluation system 106 defines the bias as follows:

Bias= [symbol] _{\tilde{p}}_{₀}[Yw^{obs}]−Eₚ_{₀}[Yw] (21)

In one or more embodiments, the off-policy embedding evaluation system 106 utilizes Kᵣ=\sqrt{regret(\hat{η}; [symbol] )} to denote the regret of the classifier, where regret(\hat{η}; [symbol] )= [symbol] (\hat{η}; [symbol] ,γ)−min_{\hat{η}}; [symbol] (\hat{η}; [symbol] ,γ). Further, in some cases, the off-policy embedding evaluation system 106 utilizes h to denote some Bregman generator. Accordingly, in one or more embodiments, the off-policy embedding evaluation system 106 determines the following bias:

$$Bias = {𝔼}_{{\tilde{p}}_{0}} [ {Yw}^{obs} ] - {E}_{{p}_{0}} [ Yw ] , \qquad ( 22 )$$

$$\leq \text{} {E}_{{p}_{0}} [ {Yw}^{obs} ] - {E}_{{p}_{0}} [ Yw ] + \sqrt{2 {v}_{0} D ( {\tilde{π}}_{0} ‖ {π}_{0} )}$$

$$\leq {E}_{{p}_{0}} [ \frac{2 \vert Y \vert}{\sqrt{{h}^{″} ( 1 )}} {κ}_{r} ] + \sqrt{2 {v}_{0} D ( \tilde{π} ‖ {π}_{0} )}$$

In function 22, the first line states the definition of the bias, the second line applies functions 18-19, and the third line applies the result of Proposition 4.1 from Arbour et al. The first term of the third line represents the error due to sample size. In particular, it represents the loss incurred due to the Bregman generator of the classifier, which vanishes as N→∞. The second term in the third line represents the error due to the discrepancy between the underlying policy π and the extrapolated policy \tilde{π}, which vanishes as d→∞.

In some cases, the off-policy embedding evaluation system 106 further determines the upper bound for the variance of the estimator as follows:

$${Var}_{{\tilde{p}}_{0}} [ {Yw}^{obs} ] \qquad ( 23 )$$

$$\leq {𝔼}_{{\tilde{p}}_{0}} [ {( {Yw}^{obs} )}^{2} ]$$

$$\leq {E}_{{p}_{0}} [ {( {Yw}^{obs} )}^{2} ] + \sqrt{2 {v}_{1} D ( {\tilde{π}}_{0} ‖ {π}_{0} )}$$

$$\leq {E}_{{p}_{0}} [ {Y}^{2} {w}_{obs}^{2} ] + {E}_{{p}_{0}} [ {Y}^{2} ( \frac{4 w}{\sqrt{{h}^{″} ( 1 )}} {κ}_{r} + \frac{4}{{h}^{″} ( 1 )} {κ}_{r}^{2} ) ] + \sqrt{2 {v}_{1} D ( {\tilde{π}}_{0} ‖ {π}_{0} )}$$

In function 23, the first inequality follows from the fact that the second moment is a trivial upper bound for the variance. The second inequality follows from functions 18-19. The third inequality follows from application of Proposition 4.2 from Arbour et al.

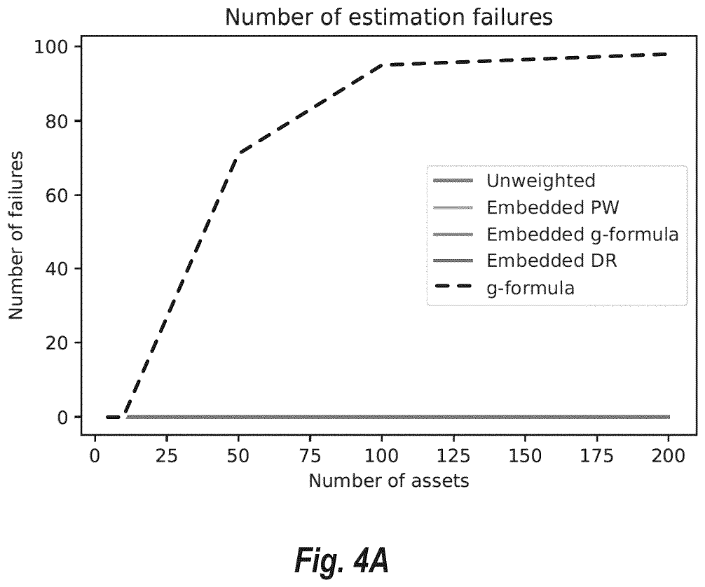

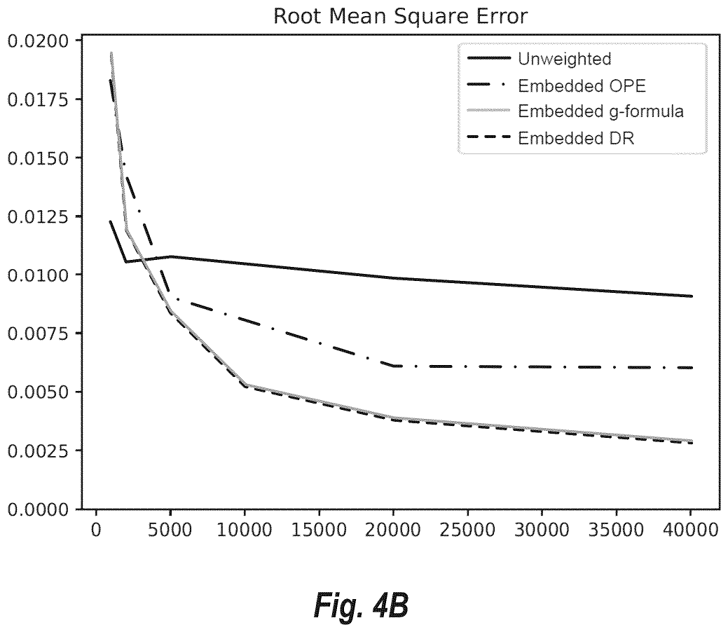

As discussed above, the off-policy embedding evaluation system 106 offers more accurate performance when compared to many conventional policy evaluation systems. In particular, the off-policy embedding evaluation system 106 can more accurately estimate the value of a target policy within a digital action space. Researchers have conducted studies to determine the accuracy of embodiments of the off-policy embedding evaluation system 106. FIGS. 4A-4B illustrate graphs reflecting experimental results regarding the effectiveness of the off-policy embedding evaluation system 106 in accordance with one or more embodiments.

The graphs of FIGS. 4A-4B compare several embodiments of the off-policy embedding evaluation system 106. In particular, the graphs compare an embodiment that utilizes the embedding permutation weighting estimator (labeled “Embedded PW”) to determine the projected performance of a target policy. The graphs also compare an embodiment that utilizes the embedded g-formula estimator (labeled “Embedded g-formula”) and an embodiment that utilizes the embedded doubly robust estimator (labeled “Embedded DR”).

The graphs compare the performance of the off-policy embedding evaluation system 106 embodiments with the performance of systems using non-embedded estimators: a non-embedded g-formula estimator (labeled “g-formula”) and an unweighted estimator (labeled “unweighted”). In some cases, the unweighted estimator represents an expected value, which can be measured as the mean of the logging policy value.

The graph of FIG. 4A provides the performance of the tested methods in a simulation where d₀=d₁=200 assets (i.e., potential digital actions for the logging policy and the target policy, respectively), m=2 contexts, and N=100 samples. Embedding spaces for each asset and query were of dimension q=2, and slates of size 1 were used. The researchers created random logging and target policies by introducing random errors into an optimal policy.

The graph of FIG. 4A compares the performance of the tested methods across one hundred datasets with various numbers of assets (e.g., available digital actions within the digital action space). The graph illustrates the stability properties of each estimator in this scenario. In particular, the graph shows the number of estimation failures of each method as the number of assets increase. As shown by the graph of FIG. 4A, the embedded estimators employed by embodiments of the off-policy embedding evaluation system 106 and the unweighted estimator perform consistently through all asset sizes (their graph lines are on top of one another within the graph). The non-embedded g-formula estimator, however, has an increasing number of failures, reaching about one hundred failures as the asset size approaches two hundred. This is due to the probability of an absolute continuity violation (on the non-embedding scale) reaching one with a fixed sample size. In some cases, this problem is exacerbated where the logging policy is deterministic.

The graph of FIG. 4B illustrates the root mean square error (RMSE) performance of each tested method as N increases and d₀ and d₁ are fixed. Specifically, the graph shows the RMSE performance of the estimated policy value compared to the true policy value. The graph of FIG. 4B does not include the non-embedded g-formula estimator as it will fail due to the absolute continuity violations.

As shown by the graph of FIG. 4B, the unweighted estimator has a relatively constant level of error. In contrast, the embodiments of the off-policy embedding evaluation system 106 using the embedded estimators start with high levels of error at small sample sizes but start to converge to zero with increasing sample size. Thus, as shown, the embodiments of the off-policy embedding evaluation system 106 can more accurately estimate the true value of a target policy, particularly when the digital action spaces are large. By improving projected performance determinations, the off-policy embedding evaluation system 106 further improves downstream applications that employ these policies. Indeed, by more accurately estimating target policy performance, the off-policy embedding evaluation system 106 facilitates the implementation of optimal policies within downstream applications (e.g., digital content recommendation systems, such as an image recommendation system or a search engine). Thus, the off-policy embedding evaluation system 106 improves the accuracy with which these downstream applications respond to certain contexts.

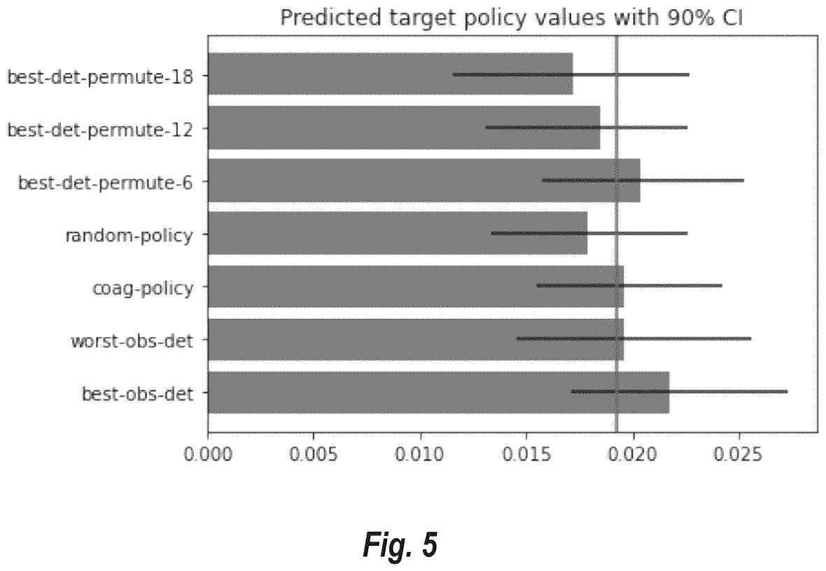

FIG. 5 illustrates a graph reflecting additional experimental results regarding the effectiveness of the off-policy embedding evaluation system 106 in accordance with one or more embodiments. In particular, the graph of FIG. 5 illustrates the performance of the embodiment of the off-policy embedding evaluation system 106 using data generated from a realistic simulation of a recommendation system.

For this experiment, the researchers extracted the top twenty queries by volume and extracted slates of size three, resulting in N=2491 observations. The digital action space included an image set of 32,188 digital images that were available to recommend. To create the action embedding vectors, the researchers extracted word tags associated with each image and passed these to an embedding model, taking the mean of the resulting action embedding vectors as the action embedding vector for the image. The initial action embedding vectors were of size [−1,1]³⁰⁰, but the researchers compressed these to size [−1,1]²⁰. To construct an embedding for a slate, the three corresponding action embedding vectors were combined for a slate embedding size of [−1,1]⁶⁰.

The target Y was whether a click was observed on the slate or not. The contexts C were the search queries. The observed click-through rate (CTR) of the original logging policy was 1.92%. The researchers created several target policies and computed the 90% confidence interval policy values.

As shown, the graph of FIG. 5 shows several policies evaluated by the off-policy embedding evaluation system 106. Starting from the bottom, the graph shows (i) the best deterministic policy as determined by grid-search over previously served slates, (ii) the worst deterministic policy determined by the same process, (iii) an implementation of the coagent policy gradient network to identify an optimal policy as described by James E. Kostas et al., Asynchronous Coagent Networks, arXiv 1902.05650, 2020, (iv) a policy that serves random slates, and (v)-(vii) corrupted versions of the best deterministic policy, whereby the slate served to K randomly selected queries is instead replaced with a random slate.

The graph illustrated in FIG. 5 shows that the resulting propensity weights result in reasonable policy values, even as policies recommend items which have never been seen before. While this would ordinarily result in an identification failure, the off-policy embedding evaluation system 106 provides reasonable results.

Turning now to FIG. 6, additional detail will now be provided regarding various components and capabilities of the off-policy embedding evaluation system 106. In particular, FIG. 6 illustrates the off-policy embedding evaluation system 106 implemented by the computing device 600 (e.g., the server(s) 102 and/or one of the client devices 110a-110n discussed above with reference to FIG. 1). Additionally, the off-policy embedding evaluation system 106 is also part of the digital content recommendation system 104. As shown in FIG. 6, the off-policy embedding evaluation system 106 includes, but is not limited to, a digital action sampler 602, an embedding generator 604, a policy evaluation manager 606, and data storage 608 (which includes digital actions 610, an embedding model 612, and a probabilistic binary classifier 614).

As just mentioned, and as illustrated in FIG. 6, the off-policy embedding evaluation system 106 includes the digital action sampler 602. In one or more embodiments, the digital action sampler 602 generates one or more sets of sampled digital actions from a digital action space. For instance, in some cases, the digital action sampler 602 generates a first set of sampled digital actions under a logging policy and a second set of sampled digital actions under a target policy. To illustrate, in some cases, the digital action sampler 602 provides a context to a policy and determines a digital action performed by the policy based on the context.

Additionally, as shown in FIG. 6, the off-policy embedding evaluation system 106 includes the embedding generator 604. In one or more embodiments, the embedding generator 604 generates action embedding vectors from digital actions. For instance, in some cases, the embedding generator 604 utilizes an embedding model to analyze a digital action and generate an action embedding vector based on the analysis. In some cases, the embedding generator 604 further generates context embeddings for contexts.

Further, as shown in FIG. 6, the off-policy embedding evaluation system 106 includes the policy evaluation manager 606. In one or more embodiments, the policy evaluation manager 606 evaluates a target policy within a digital action space. For instance, in some cases, the off-policy embedding evaluation system 106 generates a projected value metric for a target policy. In some cases, the policy evaluation manager 606 generates the projected value metric using an estimated density ratio of the target policy to a logging policy. In some instances, the policy evaluation manager 606 utilizes an embedding permutation weighting estimator to generate the projected value metric from the estimated density ratio. In some implementations, the policy evaluation manager 606 utilizes an embedded g-formula estimator. In some embodiments, the policy evaluation manager 606 utilizes an embedded doubly robust estimator.

As shown in FIG. 6, the off-policy embedding evaluation system 106 includes data storage 608. In particular, data storage 608 includes digital actions 610, the embedding model 612, and the probabilistic binary classifier 614. In one or more embodiments, digital actions 610 store available digital actions within a digital action space (e.g., digital images available for recommendation within an image dataset). In some embodiments, the embedding model 612 stores the embedding model used by the embedding generator 604 to generate action embedding vectors and/or context embeddings. Further, in some implementations, the probabilistic binary classifier 614 stores the probabilistic binary classifier used by the policy evaluation manager 606 to estimate a density ratio of a target policy to a logging policy in generating a projected value metric for the target policy.

Each of the components 602-614 of the off-policy embedding evaluation system 106 can include software, hardware, or both. For example, the components 602-614 can include one or more instructions stored on a computer-readable storage medium and executable by processors of one or more computing devices, such as a client device or server device. When executed by the one or more processors, the computer-executable instructions of the off-policy embedding evaluation system 106 can cause the computing device(s) to perform the methods described herein. Alternatively, the components 602-614 can include hardware, such as a special-purpose processing device to perform a certain function or group of functions. Alternatively, the components 602-614 of the off-policy embedding evaluation system 106 can include a combination of computer-executable instructions and hardware.

Furthermore, the components 602-614 of the off-policy embedding evaluation system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 602-614 of the off-policy embedding evaluation system 106 may be implemented as a stand-alone application, such as a desktop or mobile application. Furthermore, the components 602-614 of the off-policy embedding evaluation system 106 may be implemented as one or more web-based applications hosted on a remote server. Alternatively, or additionally, the components 602-614 of the off-policy embedding evaluation system 106 may be implemented in a suite of mobile device applications or “apps.” For example, in one or more embodiments, the off-policy embedding evaluation system 106 can comprise or operate in connection with digital software applications such as ADOBE® STOCK or ADOBE® TRADEMARK. The foregoing are either registered trademarks or trademarks of Adobe Inc. in the United States and/or other countries.

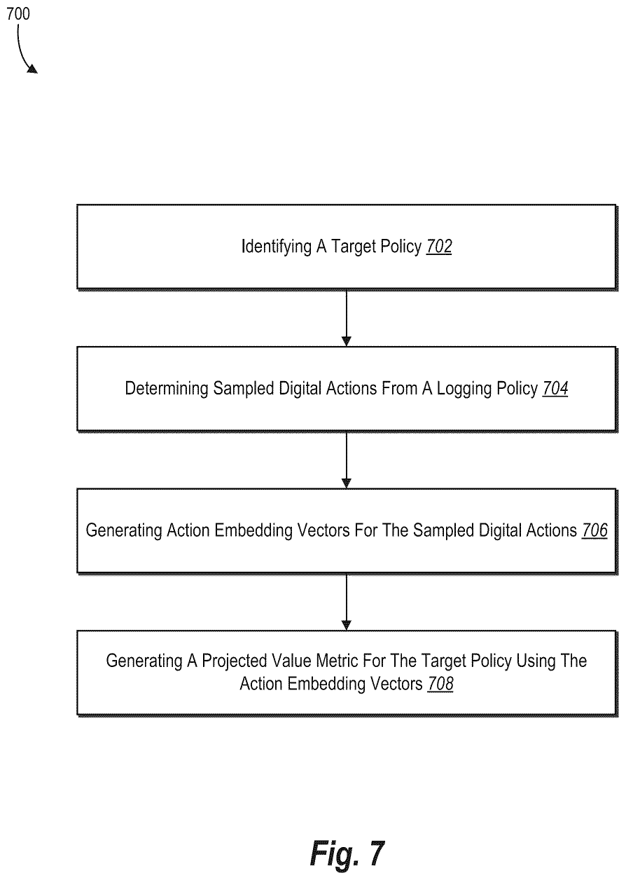

FIGS. 1-6, the corresponding text, and the examples provide a number of different methods, systems, devices, and non-transitory computer-readable media of the off-policy embedding evaluation system 106. In addition to the foregoing, one or more embodiments can also be described in terms of flowcharts comprising acts for accomplishing the particular result, as shown in FIG. 7. FIG. 7 may be performed with more or fewer acts. Further, the acts may be performed in different orders. Additionally, the acts described herein may be repeated or performed in parallel with one another or in parallel with different instances of the same or similar acts.

FIG. 7 illustrates a flowchart of a series of acts 700 for generating a projected value metric that estimates the value of a target policy within a digital action space in accordance with one or more embodiments. FIG. 7 illustrates acts according to one embodiment, alternative embodiments may omit, add to, reorder, and/or modify any of the acts shown in FIG. 7. In some implementations, the acts of FIG. 7 are performed as part of a computer-implemented method. Alternatively, a non-transitory computer-readable medium can store instructions thereon that, when executed by at least one processor, cause the at least one processor to perform operations comprising the acts of FIG. 7. In some embodiments, a system performs the acts of FIG. 7. For example, in one or more embodiments, a system includes at least one memory device comprising an embedding model. The system further includes at least one processor configured to cause the system to perform the acts of FIG. 7.

The series of acts 700 includes an act 702 for identifying a target policy. For example, in one or more embodiments, the act 702 involves identifying a target policy for performing digital actions represented within a digital action space. In one or more embodiments, the off-policy embedding evaluation system 106 identifies the target policy for performing the digital actions represented within the digital action space by identifying a recommendation policy for recommending digital content.

Additionally, the series of acts 700 includes an act 704 for determining sampled digital actions from a logging policy. For instance, in some embodiments, the act 704 involves determining a set of sampled digital actions performed according to a logging policy and represented within the digital action space. In one or more embodiments, the off-policy embedding evaluation system 106 determines the set of sampled digital actions performed according to the logging policy and represented within the digital action space by generating the set of sampled digital actions in response to a plurality of queries using the logging policy.

The series of acts 700 also includes an act 706 for generating action embedding vectors for the sampled digital actions. To illustrate, in some cases, the act 706 involves generating, utilizing an embedding model, a set of action embedding vectors representing the set of sampled digital actions within an embedding space. In some cases, the off-policy embedding evaluation system 106 generates, utilizing the embedding model, the set of action embedding vectors representing the set of sampled digital actions within the embedding space by generating the set of action embedding vectors within the embedding space that corresponds to a plurality of digital actions that are observed under the logging policy and an additional plurality of digital actions that are unobserved under the logging policy. In some instances, the off-policy embedding evaluation system 106 generates, utilizing the embedding model, the set of action embedding vectors representing the set of sampled digital actions within the embedding space by generating, for a sampled digital action from the set of sampled digital actions, an action embedding vector having a lower dimensionality than the sampled digital action and that summarizes attributes of the sampled digital action.

Further, the series of acts 700 includes an act 708 for generating a projected value metric for the target policy using the action embedding vectors. For example, in some implementations, the act 708 involves generating a projected value metric indicating a projected performance of the target policy utilizing the set of action embedding vectors.

In one or more embodiments, the off-policy embedding evaluation system 106 further determines, utilizing the set of action embedding vectors, a density ratio between the logging policy and the target policy. Accordingly, in some embodiments, the off-policy embedding evaluation system 106 generates the projected value metric indicating the projected performance of the target policy utilizing the set of action embedding vectors by generating the projected value metric utilizing the density ratio. In some implementations, the off-policy embedding evaluation system 106 determines, utilizing the set of action embedding vectors, the density ratio between the logging policy and the target policy by estimating the density ratio from the set of action embedding vectors utilizing a probabilistic binary classifier.

In one or more embodiments, the off-policy embedding evaluation system 106 further determines an additional set of sampled digital actions performed according to the target policy and represented within the digital action space; and generates, utilizing the embedding model, an additional set of action embedding vectors representing the additional set of sampled digital actions within the embedding space. Accordingly, in some embodiments, the off-policy embedding evaluation system 106 generates the projected value metric utilizing the additional set of action embedding vectors (in addition to utilizing the set of action embedding vectors from the logging policy). In some implementations, the off-policy embedding evaluation system 106 determines the additional set of sampled digital actions performed according to the target policy and represented within the digital action space by determining one or more digital actions that are unobserved under the logging policy.

In one or more embodiments, the series of acts 700 further includes acts for implementing a target policy within a digital action space. For instance, in some implementations, the acts include implementing the target policy to perform the digital actions represented within the digital action space based on the projected value metric.

To provide an illustration, in one or more embodiments, the off-policy embedding evaluation system 106 identifies a target policy for performing digital actions represented within a digital action space; generates, utilizing the embedding model, a set of action embedding vectors within an embedding space, the set of action embedding vectors representing a set of sampled digital actions from the digital action space; determines, utilizing the set of action embedding vectors, a density ratio between the target policy and a logging policy that performs one or more digital actions within the digital action space; and generates a projected value metric indicating a projected performance of the target policy utilizing the density ratio.

In some cases, the off-policy embedding evaluation system 106 generates the projected value metric utilizing the density ratio by generating the projected value metric from the density ratio utilizing an embedding permutation weighting estimator.

In some embodiments, the off-policy embedding evaluation system 106 generates the set of action embedding vectors representing the set of sampled digital actions by generating an action embedding vector having dimensions that summarize attributes of a digital action that is observed under the target policy and unobserved under the logging policy. In some instances, the off-policy embedding evaluation system 106 generates the set of action embedding vectors representing the set of sampled digital actions by generating an action embedding vector having dimensions that summarize attributes of a digital action that is observed under the target policy and observed under the logging policy.

In some implementations, the off-policy embedding evaluation system 106 determines the set of sampled digital actions from the digital action space by: generating a first set of sampled digital actions in response to a plurality of queries using the logging policy; and generating a second set of sampled digital actions in response to the plurality of queries using the target policy.

Further, in some embodiments, the off-policy embedding evaluation system 106 identifies the target policy for performing the digital actions represented within the digital action space by identifying a ranking policy for ranking search results retrieved in response to a search query.

To provide another example, in one or more embodiments, the off-policy embedding evaluation system 106 determines a set of digital actions associated with a logging policy and a target policy. The off-policy embedding evaluation system 106 further encodes the set of digital actions into a set of action embedding vectors. Further, the off-policy embedding evaluation system 106 generates a projected value metric indicating a projected performance of the target policy utilizing the set of action embedding vectors.

In some cases, determining the set of digital actions associated with the logging policy and the target policy comprises: determining a first set of digital actions associated with the logging policy; and determining a second set of digital actions associated with the target policy, the second set of digital actions comprising at least one digital action that is unobserved under the logging policy.

In some embodiments, the logging policy comprises a previously used policy that performed digital actions represented within a digital action space. Accordingly, in some implementations, the off-policy embedding evaluation system 106 replaces the logging policy with the target policy for performing the digital actions based on the projected value metric. In some instances, the previously used policy that performs the digital actions represented in the digital action space comprises a previously used recommendation policy that recommends digital images from a set of digital images.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., the server(s) 102 and/or the client devices 110a-110n). In one or more embodiments, the computing device 800 may be a mobile device (e.g., a mobile telephone, a smartphone, a PDA, a tablet, a laptop, a camera, a tracker, a watch, a wearable device). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 including storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more 110 interfaces 808, which are provided to allow a user to provide input to (such as user strokes), receive output from, and otherwise transfer data to and from the computing device 800. These 110 interfaces 808 may include a mouse, keypad or a keyboard, a touch screen, camera, optical scanner, network interface, modem, other known 110 devices or a combination of such 110 interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium storing instructions that, when executed by at least one processor, cause the at least one processor to perform operations comprising:
identifying a target policy for performing digital actions represented within a digital action space;
determining a set of sampled digital actions performed according to a logging policy and represented within the digital action space;
generating, utilizing an embedding model, a set of action embedding vectors representing the set of sampled digital actions within an embedding space; and
generating a projected value metric indicating a projected performance of the target policy utilizing the set of action embedding vectors.

2. The non-transitory computer-readable medium of claim 1, further comprising instructions that, when executed by the at least one processor, cause the at least one processor to perform operations comprising:
determining an additional set of sampled digital actions performed according to the target policy and represented within the digital action space;
generating, utilizing the embedding model, an additional set of action embedding vectors representing the additional set of sampled digital actions within the embedding space; and
generating the projected value metric utilizing the additional set of action embedding vectors.

3. The non-transitory computer-readable medium of claim 2, further comprising instructions that, when executed by the at least one processor, cause the at least one processor to perform operations comprising determining the additional set of sampled digital actions performed according to the target policy and represented within the digital action space by determining one or more digital actions that are unobserved under the logging policy.

4. The non-transitory computer-readable medium of claim 1, further comprising instructions that, when executed by the at least one processor, cause the at least one processor to perform operations comprising:
determining, utilizing the set of action embedding vectors, a density ratio between the logging policy and the target policy; and
generating the projected value metric indicating the projected performance of the target policy utilizing the set of action embedding vectors by generating the projected value metric utilizing the density ratio.

5. The non-transitory computer-readable medium of claim 4, further comprising instructions that, when executed by the at least one processor, cause the at least one processor to perform operations comprising determining, utilizing the set of action embedding vectors, the density ratio between the logging policy and the target policy by estimating the density ratio from the set of action embedding vectors utilizing a probabilistic binary classifier.

6. The non-transitory computer-readable medium of claim 1, further comprising instructions that, when executed by the at least one processor, cause the at least one processor to perform operations comprising identifying the target policy for performing the digital actions represented within the digital action space by identifying a recommendation policy for recommending digital content.

7. The non-transitory computer-readable medium of claim 1, further comprising instructions that, when executed by the at least one processor, cause the at least one processor to perform operations comprising determining the set of sampled digital actions performed according to the logging policy and represented within the digital action space by generating the set of sampled digital actions in response to a plurality of queries using the logging policy.

8. The non-transitory computer-readable medium of claim 1, further comprising instructions that, when executed by the at least one processor, cause the at least one processor to perform operations comprising generating, utilizing the embedding model, the set of action embedding vectors representing the set of sampled digital actions within the embedding space by generating the set of action embedding vectors within the embedding space that corresponds to a plurality of digital actions that are observed under the logging policy and an additional plurality of digital actions that are unobserved under the logging policy.

9. The non-transitory computer-readable medium of claim 1, further comprising instructions that, when executed by the at least one processor, cause the at least one processor to perform operations comprising generating, utilizing the embedding model, the set of action embedding vectors representing the set of sampled digital actions within the embedding space by generating, for a sampled digital action from the set of sampled digital actions, an action embedding vector having a lower dimensionality than the sampled digital action and that summarizes attributes of the sampled digital action.

10. The non-transitory computer-readable medium of claim 1, further comprising instructions that, when executed by the at least one processor, cause the at least one processor to perform operations comprising implementing the target policy to perform the digital actions represented within the digital action space based on the projected value metric.

11. A system comprising:
at least one memory device comprising an embedding model; and
at least one processor configured to cause the system to:
identify a target policy for performing digital actions represented within a digital action space;
generate, utilizing the embedding model, a set of action embedding vectors within an embedding space, the set of action embedding vectors representing a set of sampled digital actions from the digital action space;
determine, utilizing the set of action embedding vectors, a density ratio between the target policy and a logging policy that performs one or more digital actions within the digital action space; and
generate a projected value metric indicating a projected performance of the target policy utilizing the density ratio.

12. The system of claim 11, wherein the at least one processor is configured to cause the system to generate the projected value metric utilizing the density ratio by generating the projected value metric from the density ratio utilizing an embedding permutation weighting estimator.

13. The system of claim 11, wherein the at least one processor is configured to cause the system to generate the set of action embedding vectors representing the set of sampled digital actions by generating an action embedding vector having dimensions that summarize attributes of a digital action that is observed under the target policy and unobserved under the logging policy.

14. The system of claim 11, wherein the at least one processor is configured to cause the system to generate the set of action embedding vectors representing the set of sampled digital actions by generating an action embedding vector having dimensions that summarize attributes of a digital action that is observed under the target policy and observed under the logging policy.

15. The system of claim 11, wherein the at least one processor is further configured to cause the system to determine the set of sampled digital actions from the digital action space by:
generating a first set of sampled digital actions in response to a plurality of queries using the logging policy; and
generating a second set of sampled digital actions in response to the plurality of queries using the target policy.

16. The system of claim 11, wherein the at least one processor is configured to cause the system to identify the target policy for performing the digital actions represented within the digital action space by identifying a ranking policy for ranking search results retrieved in response to a search query.

17. A computer-implemented method comprising:
determining a set of digital actions associated with a logging policy and a target policy;
performing a step for encoding the set of digital actions into a set of action embedding vectors; and
generating a projected value metric indicating a projected performance of the target policy utilizing the set of action embedding vectors.

18. The computer-implemented method of claim 17, wherein determining the set of digital actions associated with the logging policy and the target policy comprises:
determining a first set of digital actions associated with the logging policy; and
determining a second set of digital actions associated with the target policy, the second set of digital actions comprising at least one digital action that is unobserved under the logging policy.

19. The computer-implemented method of claim 17,
wherein the logging policy comprises a previously used policy that performed digital actions represented within a digital action space; and
further comprising replacing the logging policy with the target policy for performing the digital actions based on the projected value metric.

20. The computer-implemented method of claim 19, wherein the previously used policy that performs the digital actions represented in the digital action space comprises a previously used recommendation policy that recommends digital images from a set of digital images.
